(19) United States
(12) Patent Application Publication
(10) Pub. No.: US 2011/0252842 A1
(43) Pub. Date: Oct. 20, 2011

(54) Secure slot lock-secure slots door locks

(76) Inventor: Nicholas Oral Morn, Las Vegas, NV (US)

(21) Appl. No.: 12/880,062

(22) Filed: Feb. 22, 2011

Related U.S. Application Data
(60) Provisional application No. 61/276,413, filed on Sep. 11, 2009.

(51) Int. Cl. E05B 65/00; E05B 15/00

(52) U.S. Cl. 70/91

(57) ABSTRACT

Security enhancing idea for improvement directly relating to a well known security vulnerability in conventional keyed cylinder locks. Secure Slots inventive improvement idea will, when implemented create a security barrier for these lock types as well as others as it solves a prior well known tampering security weakness.

### BACKGROUND OF THE INVENTION

1. Field of the Endeavor

The present invention is an idea that is a substantial improvement to the security of keyed door locksets being manufactured currently. It is directed at the prevention of unauthorized tampering of the locking latching bolt type locks. A significant security enhancing idea of improvement at a modest manufacturing expense.

2. Description of the Prior Art

It is well known that a vulnerability exists in keyed door locksets. The lockingbolts, latching bolts, deadbolts or names thereof can be tampered with, and unauthorized entry through a locked door may be gained by forcing the latching bolt to retract open by the forced insertion of, a latch engaging, lockbolt disabling, foreign object, said object is then forcefully inserted into the gap between the door and the door frame, at the latching or lockingbolt engaging point. Plastic cards, burglars tools, and flexible and rigid metal, plastic utensils etc. have been used to breech these entry, exit door lock varieties.

Various designs of door lock guards are known. In general they require the addition of extra parts and some require intricate machining as well as installation adjustments. Some of them require precise alignment and making them difficult to install and require more than a laymans knowledge and skills.

It is another object of this inventive improvement idea that no change in prior installation procedures are required and that lay persons will be able to install these improved locks.

It is another object of the present inventive improvement idea to provide a security barrier (guard) against this type unauthorized entry without adding any extra guard barrier hardware devices whatsoever.

Examples of those described above can be found in the following patents: U.S. Pat. Nos. 973,001; 1,853,456; 2,454,904; 3,271,063; 3,279,840; 3,290,081; 3,377,094; 3,405,962; 3,592,498; 3,764,173; 3,963,269.

Other known prior art patents which may be pertinent to this improvement are as follows:
U.S. Pat. No. 2,435,238, W. R. Schlage, Feb. 3, 1948;
U.S. Pat. No. 2,544,959, C. A. Hillgran, Mar. 13, 55 1951;
U.S. Pat. No. 2,623,279, C. L. Lucius, Dec. 30, 1952;
U.S. Pat. No. 2,942,449, C. White, Jun. 28, 1960.

Other Classes/Sub which may be pertinent to this improvement are as follows: 70/152, 70/224, 70/266, 70/336, 70/416, 70/476, 292/337, 292/346, 292/353 None of these known prior art patents offers the new and unique inventive improvement idea that features the significant security barrier improvement idea so disclosed herein.

### BRIEF SUMMARY OF THE INVENTION

The present invention is an idea of improvement. It has been discovered that when secure slot(s) are implemented into the latching bolt of conventional keyed cylinder locks the addition of the slot(s) provide a tamper-proof barrier that significantly increases the security of these locks and that this improvement can be implemented on other locking mechanisms as well.

An object of the present idea for, improvement, is to provide a security enhancement to newly manufactured locks A few large lock manufacturers make substantially all of the locks in the country today and this secure slot security barrier improvement can be implemented during manufacture with only a slight modification to the retractable latch bolt, locking bolt or dead bolt mechanism of conventional mass produced keyed cylindrical locksets and other lockset varieties thereby solving the security vulnerability of the prior art.

A further object of this improvement is that a minimal amount of modification to the prior art of conventional cylindrical locking latchbolts is such that the idea can be implemented in the field with relative ease.

### BRIEF DESCRIPTION OF THE SEVERAL VIEWS OF THE DRAWINGS

FIG. 1 On page 1 is a rotated overall view of a typical conventional keyed cylinder knob type door lock with the location of “Secure Slot”=“S.S” as it is clearly notated and labeled in the Legend.

FIG. 2 On page 2 is an angled view of the latching bolt mechanism of keyed cylinder door locks. These latching bolt mechanisms may also be referred as sliding lockbolts, latching bolts, lock plungers, deadbolts as well as lock cylinders. Other names may also be used to describe the latching bolt mechanism here.

FIG. 3 On page 3 is a cut away cross sectional top view of a keyed cylinder door lock, knob type, as it would appear when locked and installed with the latching bolt engaged into the door frame. The location of “Secure Slot”=“S.S” idea of improvement again is notated and labeled in the Legend on this pg. 3.

FIG. 4 On page 4 is a front and top view of the latching bolt along with various other shapes of “Secure Slots” numbers 1 thru 5 these are examples only and should not be a limit to the wide scope of variations of slot shapes that can be implemented to form the “Secure Slot ” idea of improvement. The “S.S” is again notated in the Legend on this pg. 4.

FIG. 5 On page 5 a bottom view and a frontal view of the latching bolt hardware and that of “Secure Slots” variations numbered 1-5 are single slot variations and were also depicted on pg. 4 FIG. 4 numbers 6 thru 10 are double Secure Slots variations. Again these are examples only and should not be a limit to the wide scope of variations of slot shapes that can be implemented to form the “Secure Slot(s)” an inventive idea of improvement

### DETAILED DESCRIPTION OF THE INVENTION

My invention is an idea for improvement it addresses a security weakness of conventional keyed cylinder locks. These locks are installed in doors on homes and businesses and other locations. When secure slots are machined into the locking bolt of conventional keyed cylinder locksets as referenced in the five submitted pages of drawings, a significant security barrier is created.

The secure slots can be machine cut with standard manufacturing machinery. Milling machines, boring bars, lathes and or grinding machines as well as other methods may be used to create the slots that form a “Secure Slots Door Lock”. This security enhancing improvement prevents forcing the latch bolt to retract to the open position by insertion of latch engaging objects inserted into the gap between the door and the door frame where the latch bolt is engaged.

The Secure Slots are to be cut into the latchbolt When latching bolt is viewed after lock installation the slots will be perpendicular to the floor as well as parallel to the long side of door frame. Although every conceivable variation of slots is not depicted or described any variation should be considered as obvious and novel to this application if the end result of variations not graphically illustrated in this application substantially produces a security barrier enhancement.

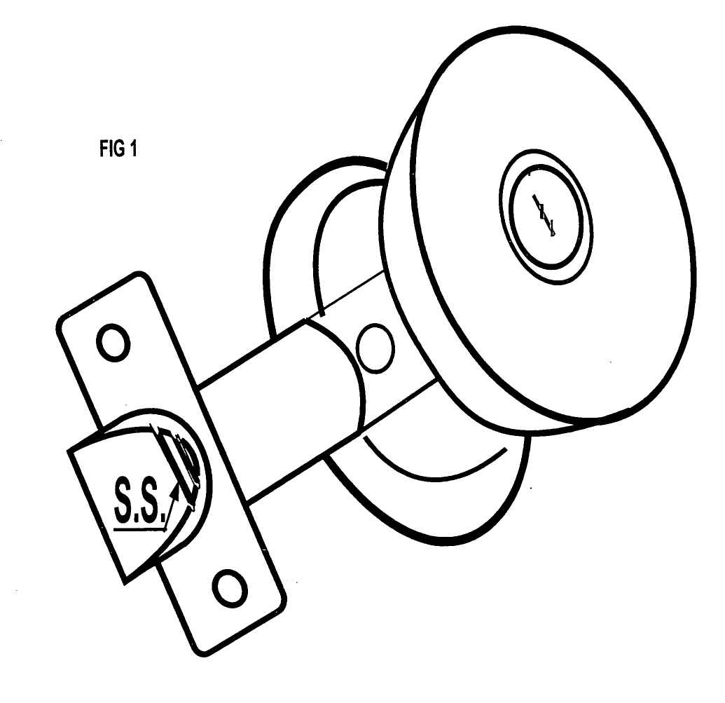

FIG. 1 on page 1 shows a conventional keyed cylinder doorknob lockset and as is noted by the Legend “S.S.=Secure Slot” graphically depicts where the secure slots are to be located. They should be of such width and length that is needed to to prevent breeching the lockset and can be single slots or more than one slot.

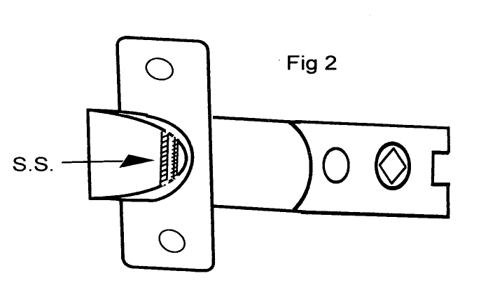

FIG. 2 on page 2 is that of the latching bolt and further denotes graphically the placement of the slots that create a barrier against forced entry.

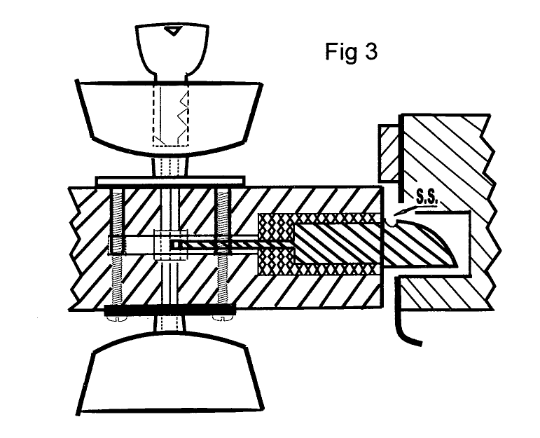

FIG. 3 on page 3 is a cutaway top view of the door, the lock and the doorframe it illustrates a typical keyed cylinder lock installed. The “Secure Slot ” security barrier is again denoted by the S.S. annotation and is referenced by Legend. Installation of conventional locksets utilizing the Secure Slots enhanced security barrier improvement will not have to be altered. Prior lock installations can be upgraded with minor tooling.

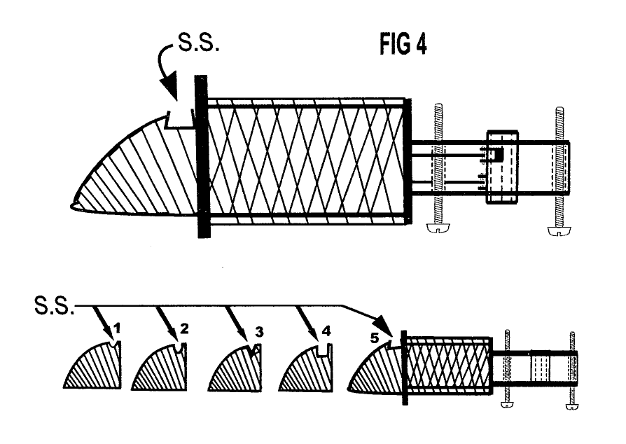

FIG. 4 on page 4, many other slot shapes could be used only 5 variations are denoted 1 thru 5. Any other shape of slot although not pictured has been contemplated by the inventor and forms a basis of novelty to this application and should be considered as obvious to this application.

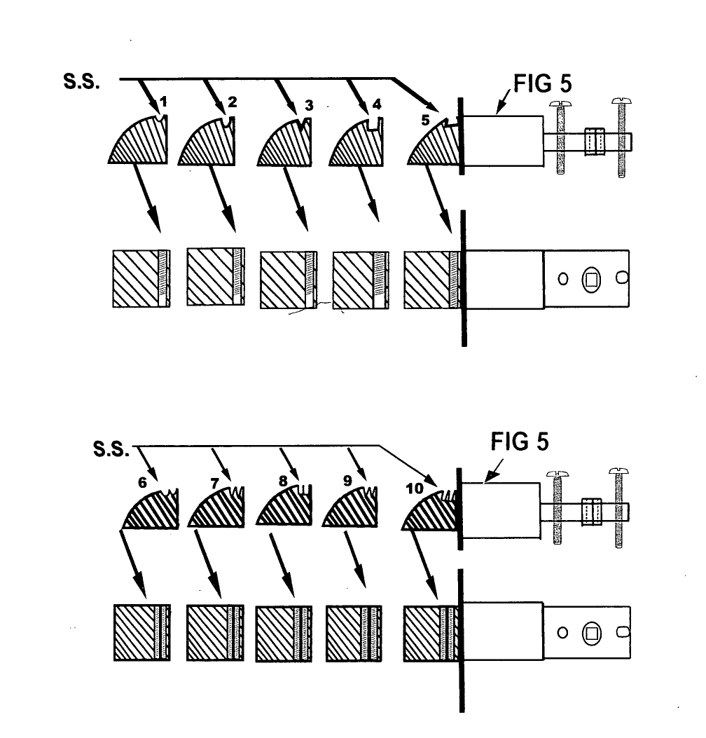

FIG. 5 on page 5, it should be noted that references 1 thru 5 are of various single Secure Slots and that reference numbers 6 thru 10 graphically illustrate double cutouts of Secure Slots and although depth, width or length has not been noted it should be understood that the slots be approximately 1/16″+/−depth, 1/16″+/− for width and full girth if desired of the locking, latch bolt. These measurements are not absolute and may vary.

What is claimed is:

1. “What I claim as my invention is” an idea for a significant improvement in the security of conventional keyed cylinder doorway locksets substantially referred to throughout this application as Secure Slot(s) and are comprised of:
Wherein, the idea for improvement is that, single or multiple slots of various shapes and sizes, whether hand tooled or machined into the locks latching bolt, they form a unique, new and effective security barrier.
Wherein, single or multiple slots are newly incorporated into the prior Art of conventional keyed cylinder lock latching bolts a new security barrier that substantially prevents forcing: back the latching bolt to gain unauthorized entry

2. “Secure Slot(s)” of claim 1. whether described as relief cut or as a process of adding slots, grooves or channels or When alternately described or suggested as slots, grooves or channels now remaining or other various descriptions that have not been graphically depicted, revealed or described, in an effort to avoid repetition, know that any and all combinations or variations that, if when used, they do create a similar idea for improvement as a security barrier and that all are obvious to this application as well.

3. “Secure Slot(s)” of claim 2. wherein said slots, grooves or channels and the numerous variety of shapes of said slots, grooves or channels that might be used to effectively implement the “secure slot lock” security barrier improvement idea have all been contemplated by the inventor and are to be considered as obvious and novel to this utility patent application.
